(19) United States
(12) Patent Application Publication
(10) Pub. No.: US 2019/0352035 A1
(43) Pub. Date: Nov. 21, 2019

(54) LABELING MACHINE, PRINTING MACHINE, INSPECTION MACHINE, AND METHOD OF COMMISSIONING A BUS SYSTEM IN SUCH A MACHINE

(71) Applicant: Krones AG, Neutraubling (DE)

(72) Inventors: Thomas EGGL, Neutraubling (DE); Joerg TRIEBEL, Neutraubling (DE)

(73) Assignee: Krones AG, Neutraubling (DE)

(21) Appl. No.: 16/468,999

(22) PCT Filed: Jul. 4, 2017
(86) PCT No.: PCT/EP2017/066697

§ 371 Date: Jun. 12, 2019

(30) Foreign Application Priority Data
Dec. 13, 2016 (DE) 10 2016 124 266.7

(51) Int. Cl. B65C 9/40; B65C 3/16; B41J 3/407; G01N 21/90; G06F 13/42

(52) U.S. Cl. CPC B65C 9/40; B65C 3/16; G06F 13/4282; G01N 21/909; B41J 3/4073

(57) ABSTRACT

The invention relates to a labeling machine, a printing machine, an inspection machine, and a method for starting up such a machine. The machine comprises at least two container receptacles, each of which has a rotary plate with a rotary plate direct drive device, and a bus unit for connecting the at least one container receptacle to a bus of a bus system in order to communicate with at least one component of an additional container handling machine or an additional component of the labeling machine and/or printing machine and/or inspection machine. The bus unit has a bus input and a bus output which are configured such that the bus unit is connected into the bus system serially relative to an additional bus unit of the bus system in order to start up the bus system, and the bus unit is configured to activate the bus output when starting up the bus system after the bus unit has received an identification number, which uniquely identifies the bus unit during a communication in the bus system, via the bus input.

### CROSS-REFERENCE TO RELATED APPLICATIONS

This application a 371 National Stage application of International Application No. PCT/EP2017/066697 filed on Jul. 4, 2017, which claims foreign priority to German (DE) Application Serial No. 10 2016 124 266.7 filed on Dec. 13, 2016, the contents of both of which are incorporated herein by reference in their entireties.

### BACKGROUND OF THE INVENTION

### Field of the Invention

The present invention relates to a labeling machine, a printing machine, an inspection machine and a method for operating a bus system in such a machine, which is configured for treating containers, such as labeling and/or filling of various products in containers, etc., and which is configured for communication between components of the machine or with additional machines of a container treatment plant via a bus system.

### Description of the Prior Art

Container treatment plants serve to treat containers, such as bottles, cans, etc., in order to prepare the containers for receiving a product, such as a beverage, a detergent, a cosmetic product, a piece good, such as a cloth, rods, etc., and/or package the containers in packaging units. Herein, at least one container treatment machine may be used, such as a filling machine, an equipment or labeling machine, a packaging machine, etc. In a filling machine, the containers are filled with the product. In an equipment or labeling machine, the containers are provided with a print and/or provided with a label. A labeling machine is known, for example, from EP 1 596 488 A2 or DE 20 2015 100 659 U1. In a packaging machine, the containers are sealed in bundles or packed in cardboard boxes or crates. If the container treatment plant comprises a plurality of container treatment machines, the containers are transported between the container treatment machines with suitable transport device(s) as additional container treatment machines.

Often, it is required that the container treatment plant for the treatment of different containers must be configured to provide, for example, differently sized containers with different equipment, such as labels or imprints, or to fill the containers with varying products or to fill the containers in differently sized packaging. For this purpose, depending on the application, various components of the container treatment plant or its container treatment machines are to be exchanged. In addition, an exchange may also be necessary in the event of a defect in the container treatment plant or for test purposes. Similarly, an extension or modernization of the container treatment plant may be required due to new components.

In all these cases, it must be taken into account that the various components of the individual container treatment machines generally have to work in coordination so that a large production yield can be achieved with the container treatment plant in the shortest possible time with the least possible waste. Therefore, the container treatment machines or their components are interconnected with a communication network, in particular a bus system. In the bus system, all communication subscribers have a unique identification number, which is also called ID, in order to be able to clearly determine which communication in the bus system is intended for the individual communication subscribers.

If a component of the individual container treatment machines is exchanged for another component, one of the communication subscribers of the bus system is thus also replaced by a new communication subscriber. This currently entails a complex reconfiguration of the bus system, since it is first required to reassign to the communication participants their unique identification number in the bus system. For example, if the exchanged component is a drive, the assignment of the identification number can be accomplished manually by means of a node selector or semi-automatically by preselecting an identification number on the bus and then manually rotating the drive. The drive which recognizes the movement reserves the preselected identification number for itself. In this way, all of the drives of the container treatment plant are to be set one after the other.

Such a procedure, in addition to the time required to be spend immediately, poses a great risk of error even for specially instructed personnel. Due to this, depending on the case and regardless of the size of the individual container treatment machines, a specially trained technician must be requested, who is not always easily available and is also expensive. This can cause expensive plant downtime and can extend such a downtime.

### SUMMARY OF THE PRESENT INVENTION

Therefore, it is an object of the present invention to provide a labeling machine, a printing machine, an inspection machine and a method for commissioning a bus system of such a machine, with which the aforementioned problems can be solved. In particular, a labeling machine, a printing machine, an inspection machine and a method are to be provided, which allow a reconfiguration of the communication network of the container treatment plant with little effort quickly and easily and beyond that error-free.

This object is achieved by a labeling machine in accordance with the presently claimed invention as set forth in the present claims. The labeling machine has at least one labeling unit for attaching at least one label to a container, at least two container receptacles, each of which has a turn table with a turn table direct driving device, and a bus unit for connecting the at least two container receptacles to a bus of a bus system in order to communicate with at least one component of an additional container handling machine or an additional component of the labeling machine, wherein the bus unit has a bus input and a bus output which are configured such that the bus unit is connected into the bus system serially relative to an additional bus unit of the bus system in order to start up the bus system, and wherein the bus unit is configured to activate the bus output when starting up the bus system after the bus unit has received an identification number, which uniquely identifies the bus unit during a communication in the bus system, via the bus input.

The aforementioned object is also achieved by a printing machine according to claim 2. The printing machine has at least one printing unit for applying at least one printing to a container, at least two container receptacles, each of which has a turn table with a turn table direct driving device, and a bus unit for connecting the at least two container receptacles to a bus of a bus system in order to communicate with at least one component of an additional container handling machine or an additional component of the printing machine, wherein the bus unit has a bus input and a bus output which are configured such that the bus unit is connected into the bus system serially relative to an additional bus unit of the bus system in order to start up the bus system, and wherein the bus unit is configured to activate the bus output when starting up the bus system after the bus unit has received an identification number, which uniquely identifies the bus unit during a communication in the bus system, via the bus input.

The aforementioned object is also achieved by an inspection machine according to claim 3. The inspection machine has at least one inspection unit for inspecting a container, at least two container receptacles, each of which has a turn table with a turn table direct driving device, and a bus unit for connecting the at least two container receptacles to a bus of a bus system in order to communicate with at least one component of an additional container handling machine or an additional component of the inspection machine, wherein the bus unit has a bus input and a bus output which are configured such that the bus unit is connected into the bus system serially relative to an additional bus unit of the bus system in order to start up the bus system, and wherein the bus unit is configured to activate the bus output when starting up the bus system after the bus unit has received an identification number, which uniquely identifies the bus unit during a communication in the bus system, via the bus input.

The above-described machines are advantageously configured such that after each reconfiguration of the bus system, the communication between the individual components of the respective machine(s) can be resumed without work input from the staff or even specially trained personnel. Herein, the bus system is also configured such that the assignment of the identification numbers for bus units of components of the respective described machine(s) can be done without errors, which components are the subscriber stations and communication participants of the bus system. As a result, a conversion of the respective machine(s) is possible without much loss of time due to the bus system. This is of great advantage, in particular where the machine is used, to which trained service personnel are not naturally available, but may have to travel from afar. As a result, the described configuration of the machines helps to make the changeover time or maintenance of the respective machine(s) as simple and fast as possible. As a result, this contributes in minimizing any downtimes caused by the configuration of the respective machine(s) and production downtimes that may occur.

Advantageous further embodiments of the machines are specified in the dependent claims.

The component may possibly be a control device whose bus unit is configured as a bus master at startup of the bus system, and each bus unit of an additional component of the bus system is configured as a bus slave at startup of the bus system, which is subordinate to the bus master in terms of control.

Preferably, the bus system is configured such that the bus master is connected to one of the bus slaves to which all other bus slaves are to be connected one after another in a row. Here, the bus system is configured such that the bus input of a bus slave is connected to a bus output of another bus slave.

According to the embodiment, the bus master is configured at startup of the bus system to transmit to each bus unit of the bus system an identification number after the bus unit, by activating the bus output of the immediately preceding bus unit, appears in the bus system.

In one implementation variant, the at least one bus unit has a transmitter and a communication controller, wherein the transmitter and/or the communication controller are configured, when the bus system is started up, to transmit the messages, which were received by the transceiver at the bus input from the bus, from the bus output to the next bus unit in the bus system. Herein, it is possible that the bus unit after completion of the startup of the bus system is configured to start a communication in the bus system in accordance with a communication protocol for a serial or parallel transmission of messages.

It is conceivable that the bus system is configured to transmit and receive messages according to the Ethernet protocol or a fieldbus protocol between the bus units after completion of the startup. Additionally or alternatively, it is conceivable that at least one component is a driving device or a sensor or a valve or a control device of the machine.

The machine may be coupled to a filling machine having as at least one component a driving device for actuating a filling valve with which the container can be filled with a product, and/or a driving device for driving a carousel for transporting the container to or away from a filling valve.

At least one of the above-described machines may be part of a container treatment plant, which also has a bus system to which the at least one machine for communication via a bus is connected to an additional container treatment machine and/or to which are connected at least two components of the at least one machine and/or to which is connected a control device of the container treatment plant.

This object is also achieved by a method for starting a labeling and/or printing machine and/or inspection machine according to claim 12. The machine has at least two container receptacles, each having a turntable and a turntable direct driving device. The method comprises the steps of: connecting a bus unit of the at least two container receptacles to a bus of a bus system for communicating with at least one component of an additional container treatment machine or with an additional component of the labeling machine and/or printing machine and/or inspection machine, wherein the bus unit has a bus input and a bus output configured such that the bus unit for starting up the bus system is serially connected in the bus system to an additional bus unit of the bus system, and starting up the bus system, wherein the bus output of the bus unit is activated after the bus unit has received via the bus input an identification number which uniquely identifies the bus unit during a communication in the bus system.

The method achieves the same advantages as previously described with respect to the machines.

Further possible implementations of the invention also include not explicitly mentioned combinations of features or implementations described above or below with regard to the embodiments. The person skilled in the art will also add individual aspects as improvements or additions to the respective basic form of the invention.

### BRIEF DESCRIPTION OF THE DRAWINGS

The invention is described below with reference to the accompanying drawings and on the basis of an exemplary embodiment.

FIG. 1 is a greatly simplified plan view of a container treatment plant according to a first embodiment;

FIG. 2 is a schematic block diagram of a bus system for a container treatment plant of FIG. 1;

FIG. 3 is a partial side view of a labeling machine for a container treatment plant according to a second embodiment;

FIG. 4 is a partial side view of a printing machine for a container treatment plant according to a third embodiment; and

FIG. 5 is a partial side view of an inspection machine for a container treatment plant according to a fourth embodiment.

### DETAILED DESCRIPTION OF THE PRESENT INVENTION

In the figures, identical or functionally identical elements, unless otherwise indicated, are provided with the same reference signs.

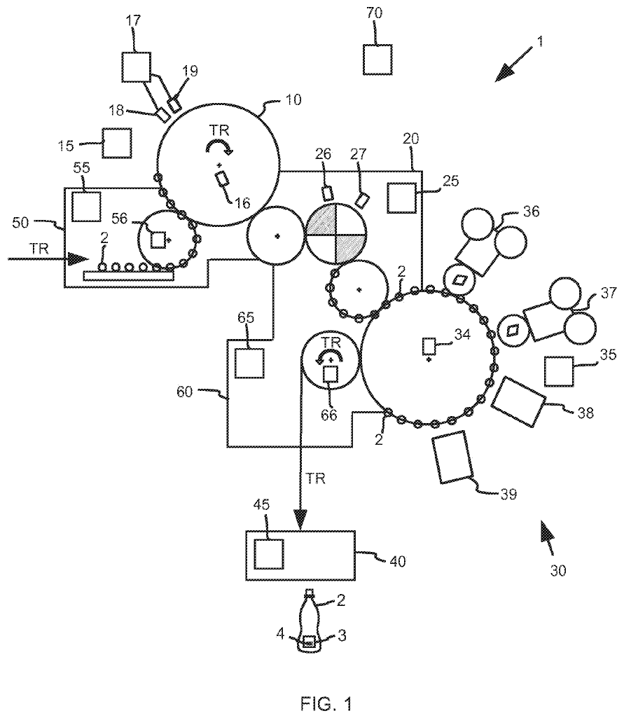

FIG. 1 shows a container treatment plant 1 for the treatment of containers 2, which can be bottles, cans, boxes, etc., which can be provided with a very schematically illustrated label 3 and/or any printing 4 as a label.

For this purpose, the container treatment plant 1 comprises as an example a first to fourth container treatment machine 10, 20, 30, 40, which are coupled together. However, the container treatment plant 1 may also have only one or two or three of the container treatment machines 10, 20, 30, 40. There may also be more container treatment machines 10, 20, 30, 40. As a result, any number of container handling machines 10, 20, 30, 40 is possible. In FIG. 1, not all of the containers 2 are shown or provided with a reference sign for the sake of simplicity.

The container 2 may for example be a container having a capacity of a maximum of about 0.33 Liters or 0.5 liters or 1.5 liters, etc. Of course, other capacities are conceivable. Herein, the shape of the container 2 can be chosen freely. In addition, the material of the container 2 can be freely selected, such as glass, plastic, aluminum, etc.

In the inlet of the first container treatment machine 10, a transport device 50 is provided which, under the control of a control device 55 and with the aid of the drive by a driving device 56 of the first container treatment machine 10, supplies containers 2 in a row or as a container stream. The transport direction TR of the containers 2 is indicated in each case by arrows in FIG. 1 and also results from the row of containers 2 along the container treatment machines 10, 20, 30, 40. Between the third and fourth container treatment machines 30, 40, the containers 2 are transported by a transport device 60 under control of a control device 65 by means of a drive of a driving device 66. In the example in FIG. 1, the container treatment machines 10, 20, 30, 40 and the transport devices 50, 60 are each implemented as a multifunction star or carousel or comprise at least one multifunction star or a carousel, which is driven by the associated driving device 56, 66,

In the example of FIG. 1, the container treatment machines 10, 20, 30, 40 and the conveyors 50, 60 form a block which is constructed very compact. Also the fourth container treatment machine 40 can be arranged in the vicinity of or also adjacent to the block of the container treatment machines 10, 20, 30 and the transport devices 50, 60, although this is not shown in FIG. 1. However, the container treatment plant 1 and the container treatment machines 10, 20, 30, 40 are not limited thereto and may be lined up in a separate configuration.

In the example of FIG. 1, the first container treatment machine 10 is a filling machine controlled by a control device 15. In this case, the containers 2 are moved by driving a driving device 16 to filling valves, not shown, with which from at least one filling tank 17 at least one product is filled into the container 2 supplied by the transport device 50. The filling valves are actuated by means of driving devices 18, 19. The product may be, for example, a food, in particular a beverage, etc., or a detergent or a cosmetic product or a powder or a piece good, in particular pellets, etc., or any other product that is Tillable into containers 2. At the filling tank 17, a sensor for measuring the level of the product in the filling tank 17 may be provided, too. For the sake of simplicity, such a sensor and also other possible sensors, for example for detecting the position of the filling valve and/or the container 2 at the filling valve, etc., are not shown here.

In the example of FIG. 1, the second container treatment machine 20 is a capper, positioned downstream of the filling machine or the first container treatment machine 10. In the capper as a second container treatment machine 20, the containers 2 are provided and thereby closed under the control of a control device 25 by means of, for example, at least one screw driving device 26, 27 with a closure cap. For simplicity, other components of the second container treatment machine 20 are not shown and described.

In the example of FIG. 1, the third container treatment machine 30 is an equipment machine which provides the containers 2, which are filled by the filling machine or first container treatment machine 10 and then closed with the second machine 20, with a marking by the label 3 and/or an arbitrary printing 4, for example. For this purpose, the equipment machine in the example of FIG. 1 has a driving device 34 which, under the control of a control device 35, drives a carousel for transporting the containers 2 past four different modules, which in particular are equipment modules 36, 37, 38, 39. For example, the equipment module 36 is a labeling and/or printing unit, the equipment module 37 is a labeling unit and the equipment modules 38, 39 are configured as printing units. As a result, the label 3 can be a prefabricated label. However, the label 3 can also be printed at least partially by means of a labeling and/or printing unit, which is illustrated by the printing 4. Alternatively, the labeling and/or printing unit can also print at least partially directly on the label 3 or the container 2. In particular, with the labeling and/or printing unit or the printing units with a printer, such as an inkjet or laser printer, an additional marking can be printed on the container 2 to ensure traceability of the container 2 or products.

Alternatively, however, the equipment modules 35 to 38 can each be configured identically so that all the containers 2 are provided with the same type of markings, in particular labels 3. In the case shown in FIG. 1, the containers 2 can be provided in particular with different types of labels, such as waist and/or breast label and/or wrap-around label from the roll or as a sheet and/or self-adhesive label and/or cold glue label and/or hot glue label. There are any combinations of equipment modules 35 to 38 and thus varieties of labels, in particular labels types, conceivable and feasible.

For simplicity, other components of the third container treatment machine 30, such as in particular print heads, sensors, driving devices for label rolls, etc. are not shown and described.

After the third container treatment machine 30, the equipment machine in the previously selected example, the containers 2 are fed by means of the transport device 60 to the fourth container treatment machine 40, as already mentioned above.

The fourth container treatment machine 40 is, for example, a packaging machine in which the containers 2 are packaged together under control of a control device 45 into predetermined types and/or package sizes, for example, as bundles with two containers 2 or four containers 2, with or without handle, etc. or in a crate or cardboard box, etc. For the production of, for example, bundles or also for the cardboard boxes, a shrinking station may be provided.

The container treatment plant 1 is controlled by a control device 70. For the individual machines 10, 20, 30, 40 and the transport devices 50, 60, the aforementioned control devices 15, 25, 35, 45, 55, 65 or even more or less, i.e. any number of control devices may be present, which are subordinated to the control device 70 in terms of control.

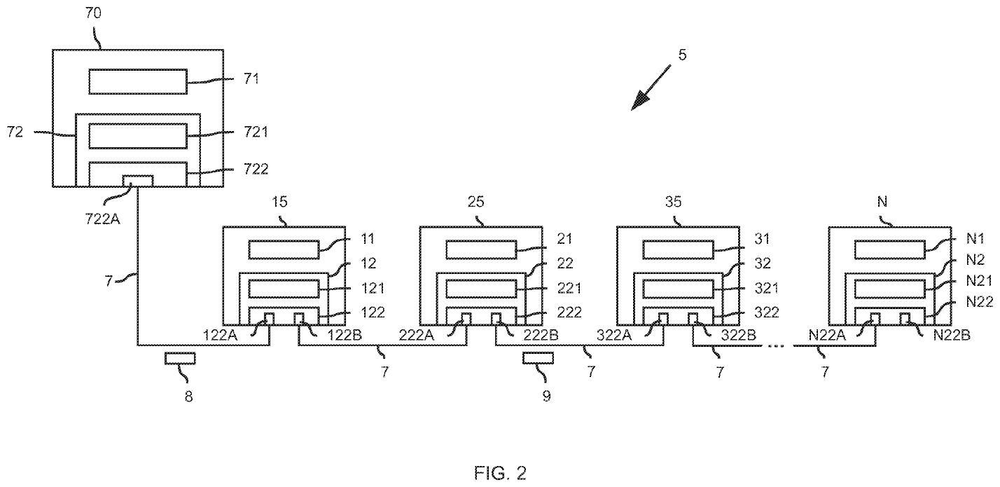

FIG. 2 shows in a highly simplified manner a bus system 5 which is usable in the container treatment plant 1 for a communication of the previously described components of the container treatment plant 1, such as the control devices 15, 25, 35, 45, 55, 65, 70, the driving devices 16, 18, 19, 26, 27, etc., the individual modules 36, 37, etc., with each other. However, in order to simplify the illustration, only one connection of the control devices 15, 25, 35, 70 and N is illustrated in FIG. 2, even if in fact all other components of the machines 10, 20, 30, 40 and/or the transport devices 50, 60 may be part of the bus system 5, as well.

According to FIG. 2, the control devices 15, 25, 35, 70 and a component N are connected to one another via a bus 7. Herein, N signifies any number and combination of the control devices 45, 55, 65 and/or the driving devices 16, 18, 19, 26, 27, etc. and/or the individual modules 36 to 39, etc. and/or other components of the container treatment plant 1, which are not shown in greater detail, and/or their individual machines 10, 20, 30, 40 and transport devices 50, 60.

The control devices 15, 25, 35, 70 and the component N are subscriber stations of the bus 7. The subscriber stations can exchange messages 8, 9 in the form of signals via the bus 7. The messages 8, 9 can be addressed to at least one of the subscriber stations of the bus 7.

The control device 70 has a general control unit 71, which is configured for the control tasks of the container treatment plant 1, as described above as a simplified example. In addition, the control device 70 has a bus unit 72, which has a communication controller 721 and a transceiver 722. The transceiver 722 is connected to the bus 7 via a bus enable component 722A which implements a bus input and a bus output (not shown).

The control device 15 has a general control unit 11, which is configured for the control tasks of the first container treatment machine 10 or its treatment functions, as described above as an example. In addition, the control device 15 has a bus unit 12, which has a communication controller 121 and a transmitter 122. The transceiver 122 has a bus input 122A and a bus output 122B, which are connected to the bus 7, respectively. The bus input 122A is connected via the bus 7 to the bus enable component 722A and thus to the controller 70.

The control device 25 has a general control unit 21, which is configured for the control tasks of the second container treatment machine 20, as described above as an example. In addition, the control device 25 has a bus unit 22 which has a communication controller 221 and a transceiver 222. The transceiver 222 has a bus input 222A and a bus output 222B, which are connected to the bus 7, respectively. The bus input 222A is connected via the bus 7 to the bus output 122B and thus to the control device 15.

The control device 35 has a general control unit 31, which is configured for the control tasks of the third container treatment machine 30, as described above, for example. In addition, the control device 35 has a bus unit 32, which has a communication controller 321 and a transceiver 322. The transceiver 322 has a bus input 322A and a bus output 322B, which are connected to the bus 7, respectively. The bus input 322A is connected via the bus 7 to the bus output 222B and thus to the control device 25.

The Nth component of the container treatment facility 1 has a functional unit N1 configured to perform the function of the Nth component, as described above as an example. In addition, the Nth component has a bus unit N2 having a communication controller N21 and a transceiver N22. The transceiver N22 has a bus input N22A and a bus output 322B, which are connected to the bus 7, respectively. The bus input N22A is connected via the bus 7 to the bus output 222B and thus in FIG. 1 as an example to the control device 35.

The communication controller 121 may generate messages 8, 9 according to any communication protocol and forward them to the transceiver 122 for transmission onto the bus 7 or may process messages 8, 9 received by the transceiver 122. In particular, the communication protocol may be a real-time communication protocol, such as the Ethernet protocol, any fieldbus protocol, etc. The communication controllers 221, 321, N21 and transceivers 222, 322, N22 are preferably implemented in the same manner as the devices 121, 122. However, it is possible that at least one of the bus units 12, 22, 32, 72, N2 has additional functions which the other bus units do not have, provided that the bus units 12, 22, 32, 72, N2 are configured for communicating with each other via the bus 7.

The messages 8 contain an identification number or ID, which is unique for the individual bus units 12, 22, 32, N2. Messages 8 are sent especially at power-up of the bus system 5, as described below. The messages 9 are messages that can be sent after the start-up of the bus system 5 via the bus 7 between the individual bus units 12, 22, 32, N2 during operation of the bus system 5.

In addition, the bus input 122A and the bus output 122B of the control device 15 are configured such that the bus unit 12 is serially connected to the bus unit 22 in the bus system 5 in order to start up the bus system 5. In addition, in order to start up the bus system 5, the bus unit 22 is connected in series to the bus unit 32 in the bus system 5. In addition, in order to start up the bus system 5, the bus unit 32 is connected in series to the bus unit N2 in the bus system 5. Thus, all of the control devices 15, 25, 35, 70, N can be connected in series via the bus 7 in the bus system 5.

If now the bus system 5 is started up for commissioning or reconfiguration of the bus system 5 or after switching on the container system 1, all bus units 12, 22, 32, N2 deactivate their bus output. This setting can be set via a preselection to the respective bus unit 12, 22, 32, N2.

Due to the inactive bus outputs, the control device 70 as the bus master only sees the bus unit 12 as the only additional bus subscriber or subscriber station in the bus system 5. The bus unit 12 is at startup of the bus system 5, a bus slave, which is subordinate to the bus master in terms of control.

The control device 70 therefore creates a message 8 in which an identification number or ID for the bus unit 12 and thus the control device 15 is contained in the bus system 5. The identification number is provided and allocated to the bus unit 12 and uniquely identifies the bus unit 12 for the communication in the bus system 5. The identification number may be the first free address on the bus 7.

If the transceiver 122 has received the message 8 and forwarded it to the communication controller 121, the identification number contained in the message 8 is stored in the bus unit 12, for example in a memory of the communication controller 121. As a result, the communication controller 121 may use the identification number for the further communication in the bus system 5. As a further consequence of this, the bus unit 12 switches its bus output 122 active. Thus, the bus unit 22 is connected to the bus 7, so that the control device 70 sees now also the bus unit 22 as another bus slave. Thus, the bus input 222A of the bus unit 22 is connected as a bus slave to the bus output 122B of the bus unit 12 as another bus slave.

The control device 70 therefore creates a new message 8, in which an identification number or ID for the bus unit 22 and thus the control device 25 is contained in the bus system 5. The message 8 is sent by the control device 70 via the bus 7 to the bus unit 12 and forwarded by the latter to the bus unit 22. The transceiver 122 does not forward the new message 8 to the communication controller 121 because the new message 8 is not provided with the identification number of the bus unit 12.

The bus unit 22 receives the new message 8 with the identification number provided for the bus unit 22. Subsequently, the bus unit 22 proceeds in the same manner as described above with respect to the bus unit 12. Thus, the identification numbers or addresses for the bus units 12, 22, 32, N2 are automatically assigned in the order of physical construction of the bus 7.

As a result, a method for commissioning or starting up a bus system 5 of the previously described container treatment machine 1 is carried out. As a result, commissioning or start-up of the previously described container treatment machine 1 can also take place. The switching of the bus outputs 122B. 222B, 322B, N22B from active to inactive or from inactive to active may be performed by means of a switch which may be hardware-implemented and/or at least partially software-implemented.

If all bus units 12, 22, 32, N2 have received a message 8 with the respective intended identification number, a communication in the bus system 5 can be started according to a communication protocol for a serial or parallel transmission of messages or messages 9. The messages 9 may include detection result(s), feedback(s), command(s), etc. In each case, the bus units 12, 22, 32, 72, N2 process only messages 9 which are assigned to the identification number allocated for the bus units 12, 22, 32, N2. The bus units 12, 22, 32, 72, N2 in each case forward the messages 9 to the next bus unit.

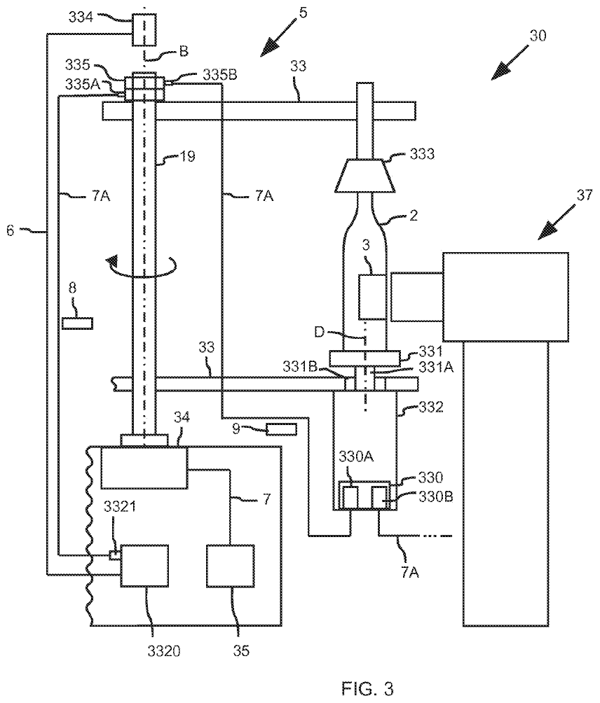

FIG. 3 shows in a side view a labeling machine as a third container treatment machine 30 for a container treatment plant according to a second embodiment. The container treatment machine 30 can be set up as a single machine or can again be integrated at least via the bus 7 into the container treatment machine 1 according to the preceding embodiment, as described above, or can be integrated into a part of the machine 1 according to the preceding embodiment.

According to FIG. 3, the labeling machine or third container treatment machine 30 has a rotatable transport carousel 33, the non-rotatably positioned control device 35 and the equipment module 37 configured as a labeling unit. The transport carousel 33 serves for receiving turntables 331, each having an associated turntable direct driving device 332 and an associated centering element 333. The turntables 331 form together with the respectively associated centering element 333 container receptacles 331, 333, which are arranged outside the circumference of the transport carousel 33 and rotate with the transport carousel 33. For the sake of clarity, only one container receptacle 331, 333 with a direct driving device 332 is shown here. At the periphery of the transport carousel 33, however, are located a plurality of such arrangements 331, 332, 333 at regular angular intervals. A shaft seal system, in which at least one sealing ring 331B abuts to a motor shaft 331A of the turntable direct driving device 332, serves to protect the turntable direct driving device 332 against contamination.

The direct driving device 332 shown in FIG. 3 is connected to the bus 7 by a bus unit 330 via a bus input 330A and a bus output 330B. Preferably, however, each of the direct driving devices 332 is connected to the bus 7 one after the other or serially via a bus input 330A and a bus output 330B. For simplicity, the communication controller and transmitter of the bus unit 330 are not shown here. To set up the bus 7, the messages 8 are sent as previously described with respect to the first embodiment.

Each turntable 331 can be individually driven by a direct driving device 332 in a revolution about its turntable axis D. The transport carousel 33 is rotatable about its carousel axis B by means of the driving device 34. The driving device 34 is controlled via the control device 35, as already described with respect to the first embodiment. For this purpose, the driving device 34 may also be connected to the control device 35 via the bus 7. In addition, for controlling the direct driving device(s) 332, a control device 3320 is provided, which is connected to the direct driving device(s) 332 via a bus actuating component 3321 via a bus 7A.

In the example of FIG. 3, an absolute angle encoder or rotation angle sensor 334 is arranged above the transport carousel 33. The signal of the absolute angle encoder or rotation angle sensor 334 indicates a transportation carousel position and is forwarded via a communication line 6 directly to the control device 3320 for the direct driving device (s) 332 and read there. In addition, a slip ring 335 is disposed above the transport carousel 33 on the carousel axis B. The slip ring transformer 335 is connected to the bus 7A via an input 335 and an output 335B. With the signal of the rotation angle sensor 334 it can be determined which turntable 331 is currently positioned on the labeling unit or the equipment module 37. As described below, the control device 3320 may use the detection value of the rotation angle sensor 334 to drive the direct driving devices 332.

In operation, one of the containers 2 at a time is clamped between a turntable 331 and the associated centering element 333 and guided past the equipment module 37 by the rotation of the transport carousel 33 about the carousel axis B. When labeling, the containers 2 are rotated in a defined manner about the turntable axis D by means of the direct driving device 332, so that the label 3 is attached as evenly as possible to the container circumference. When passing by the labeling unit or equipment module 37, the container receptacles are pivoted synchronously with the application of the label 3, so that the labels 3 are mounted as evenly as possible on the circumference of the container 2. Herein, each of the turntables 331 is individually rotatable with a turntable direct driving device 332. This allows that each turntable 331 is individually driven by the machine control or control device 35 for the labeling process and is particularly flexible adaptable to different label and container types. However, a rotation for the transfer of the label 3 is only optional, it may also be that the containers 2 are rotated during transport between individual labeling units 37 and stand again for labeling.

The bus 7A according to FIG. 3 is constructed as at least one separate bus to the bus 7A. The control devices 35, 3320 can in turn be connected to the other control devices of the container treatment plant 1 of the first embodiment via the bus system 5 which is the same for both buses 7, 7A, for example Powerlink, etc., as shown in FIG. 2.

Apart from that, the buses 7, 7A and the bus system 5 formed therewith are implemented in the same manner as described in the first embodiment.

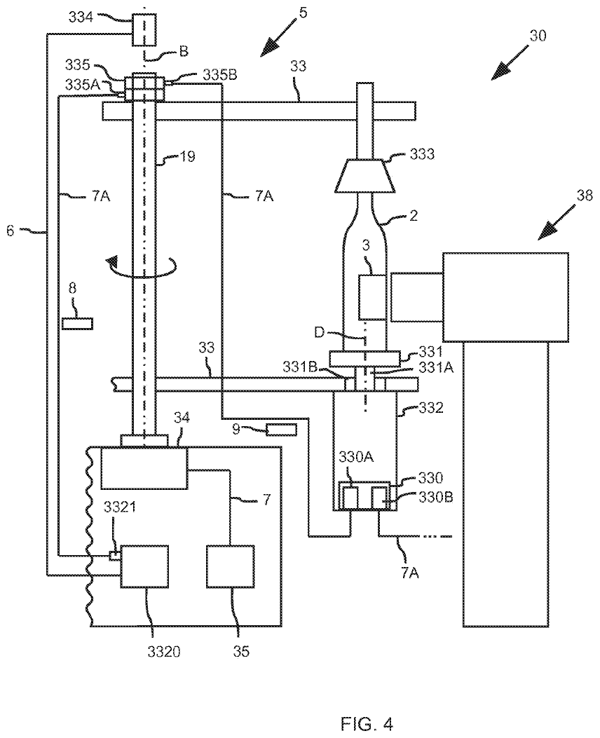

FIG. 4 shows in a side view a printing machine as a third container treatment machine 30 for a container treatment plant according to a third embodiment. The printing machine can be set up as a single machine. Alternatively, the printing machine can be integrated via the bus 7 into the entire or in a part of the container treatment machine 1 according to the preceding embodiment, as described above.

Referring to FIG. 4, the printing machine or third container treatment machine 30 is constructed in most parts in the same manner as described above with respect to the second embodiment. However, instead of the equipment module 37 of FIG. 3, an equipment module 38 configured as a printing unit is present.

In operation, therefore, one of the containers 2 at a time is clamped between a turntable 331 and the associated centering element 333 and guided past the equipment module 38, which is formed as a printing unit, by the rotation of the transport carousel 33 about the carousel axis B. When printing, the containers 2 are rotated in a defined manner about the turntable axis D by means of the direct driving device 332, so that the printing 4 is attached as uniformly as possible to the container circumference. Herein, the control of the container receptacles and the turntable direct driving device 332 is performed as described above with respect to the second embodiment.

Apart from that, the buses 7, 7A and the bus system 5 formed therewith are implemented in the same manner as described in the preceding embodiments.

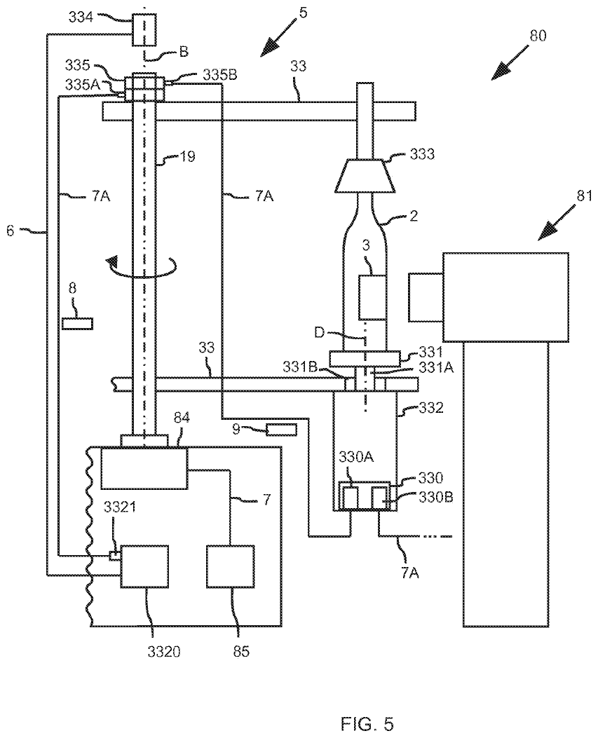

FIG. 5 shows in a side view an inspection machine 80 for a container treatment plant according to a fourth exemplary embodiment. The inspection machine 80 can be set up as a single machine. Alternatively, the inspection machine 80 may be integrated via the bus 7 into the entire or a part of the container treatment machine 1 according to the previous embodiment, as described above. For example, the inspection machine 80 is positioned downstream of the container treatment machine 30. Additionally or alternatively, however, an inspection machine 80 may be positioned in the supply unit of the container treatment machine 30.

Referring to FIG. 5, the inspection machine 80 is constructed in most parts in the same manner as described above with respect to the second embodiment. However, instead of the equipment module 37 of FIG. 3, an inspection unit 81 is present, which can be configured in particular as a camera. In addition, instead of the control device 35, a non-rotatably positioned control device 85 is provided which can control a driving device 84 for driving the transport carousel 33.

In operation, one of the containers 2 at a time is clamped between a turntable 331 and the associated centering element 333 and guided past the inspection unit 81 by the rotation of the transport carousel 33 about the carousel axis B. When inspecting with the inspection unit 81, the containers 2 are rotated in a defined manner about the turntable axis D by means of the direct driving device 332, so that the container 2 can be examined from all sides as evenly as possible for flaws. Herein, the control of the container receptacles and the turntable direct driving devices 332 is performed by the control device 3320 as described above with respect to the second embodiment.

Apart from that, the buses 7, 7A and the bus system 5 formed therewith are implemented in the same manner as described in the preceding embodiments.

All of the above-described implementations of the container treatment plant 1 and of the method performed by the machine for treating containers 2, the bus system 5 and the method for commissioning or starting up the bus system 5 described in this regard can be used individually or in all possible combinations. In particular, the features of the embodiments described above can be combined arbitrarily or can even be omitted. Moreover, in particular, the following modifications are conceivable.

The elements shown in the figures are depicted schematically and may differ in the specific implementation from the forms shown in the figures provided that the above-described functions are ensured.

At least one of the container treatment machines 10, 20, 30, 40 may be an inspection machine for inspecting the containers 2 for flaws. At least one of the container treatment machines 10, 20, 30, 40 may be a cleaning machine for cleaning the at least one container 2. Of course, all other container treatment machines are also possible as a container treatment machine(s) 10, 20, 30, which are configured for the treatment of containers 2. The container treatment plant 1 may comprise container treatment machines 10, 20, 30, 40 in any number, combination and implementation, and/or additional container treatment machines, as described above, in any number, combination and implementation, which are positioned optionally in front of and/or between and/or behind transport devices 50, 60.

As an alternative to the physical bus topology shown in FIG. 2, the bus units 12, 22, 32, 72, N2 may be connected to each other in a star layout. In this case, the bus input 122A and the bus output 122B of the individual bus unit 12 are configured such that the bus unit 12 is connected in series to the bus unit 22 in the bus system 5 at least to start up the bus system 122B. The same applies mutatis mutandis to the bus units 22, 32, 72, N2, so that even in the case of the star topology a serial connection of all bus units 12, 22, 32, 72, N2 is present.

The bus units 12, 22, 32, 72, N2 for all components of the container treatment plant 1 can be divided into different buses 7, which are connected to one another, for example, via the control devices 15, 25, 35, 45, 55, 65, 70. This may be advantageous, in case a bus 7 is unfavorable or not acceptable for all components of the container treatment plant 1 for reasons of a deterioration of the signal quality and therefore the reduction of the possible data transmission rate.

### LIST OF REFERENCE SIGNS

| | |
|---|---|
| 1 | container treatment plant |
| 2 | container |
| 3 | label |
| 4 | printing |
| 5 | bus system |
| 6 | communication line |
| 7, 7A | bus |
| 8, 9 | message |
| 10 | first container treatment machine, filling |
| | machine |
| 11, 21, 31, 71, N1 | control unit |
| 12, 22, 32, 72, N2, 330 | bus unit |
| 15, 25, 35, 45, 55, | control device (component) |
| 65, 70, 85, 3320 | |
| 16, 18, 19 | driving device (component) |
| 17 | filling tank (component) |
| 20 | second container treatment machine, capper |
| 26, 27, 34, 56, 66, 84 | driving device (component) |
| 30 | third container treatment machine, |
| | equipment machine, labeling machine and/or |
| | printing machine |
| 33 | transport carousel |
| 36 up to 39 | module, equipment module (component) |
| 40 | fourth container treatment machine, |
| | packaging machine |
| 50 | first transport device |
| 60 | second transport device |
| 80 | inspection machine |
| 81 | inspection unit |
| 121, 221, 321, 721, N21 | communication controller |
| 122, 222, 322, 722, N22 | transceiver |
| 122A, 222A, 322A, 332A, | bus input |
| N22A | |
| 122B, 222B, 322B, 332B, | bus output |
| N22B | |
| 331 | turntable |
| 331 A | motor shaft |
| 331 B | sealing ring(s) |
| 332 | turntable direct driving device (component) |
| 333 | centering element |
| 334 | absolute angle encoder or rotation angle |
| | sensor |
| 335 | rotary distributor or slip ring transmitter |
| 335A | bus input |
| 335B | bus output |
| 722A, 3321 | bus enable component |
| B | carousel axis |
| D | turntable axis |
| TR | transport direction |

Having described preferred embodiments of the invention, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. A labeling machine, comprising:
at least one labeling unit for attaching at least one label to a container;
at least two container receptacles, each of which has a turn table with a turn table direct driving device; and
a bus unit for connecting the at least two container receptacles to a bus of a bus system in order to communicate with at least one component of an additional container handling machine or an additional component of the labeling machine;
wherein the bus unit has a bus input and a bus output which are configured such that the bus unit is connected into the bus system serially relative to an additional bus unit of the bus system in order to start up the bus system; and
wherein the bus unit is configured to activate the bus output when starting up the bus system after the bus unit has received an identification number, which uniquely identifies the bus unit during a communication in the bus system, via the bus input.

2. A printing machine, comprising:
at least one printing unit for applying at least one printing to a container;
at least two container receptacles, each of which has a turn table with a turn table direct driving device; and
a bus unit for connecting the at least two container receptacles to a bus of a bus system in order to communicate with at least one component of an additional container handling machine or an additional component of the printing machine;
wherein the bus unit has a bus input and a bus output which are configured such that the bus unit is connected into the bus system serially relative to an additional bus unit of the bus system in order to start up the bus system; and
wherein the bus unit is configured to activate the bus output when starting up the bus system after the bus unit has received an identification number, which uniquely identifies the bus unit during a communication in the bus system via the bus input.

3. An inspection machine comprising:
at least one inspection unit for inspecting a container;
at least two container receptacles, each of which has a turn table with a turn table direct driving device; and
a bus unit for connecting the at least two container receptacles to a bus of a bus system in order to communicate with at least one component of an additional container handling machine or an additional component of the inspection machine;
wherein the bus unit has a bus input and a bus output which are configured such that the bus unit is connected into the bus system serially relative to an additional bus unit of the bus system in order to start up the bus system; and
wherein the bus unit is configured to activate the bus output when starting up the bus system after the bus unit has received an identification number, which uniquely identifies the bus unit during a communication in the bus system, via the bus input.

4. The machine according to claim 1, wherein the component is a controller whose bus unit is configured as a bus master at startup of the bus system, and each bus unit of an additional component of the bus system is configured as a bus slave at startup of the bus system, which is subordinate to the bus master in terms of control.

5. The machine according to claim 1, wherein the bus system is configured such that the bus master is connected to one of the bus slaves, to which all other bus slaves are to be connected one after another in a row.

6. The machine according to claim 1, wherein the bus master is configured at startup of the bus system to transmit to each bus unit of the bus system an identification number after the bus unit, by activating the bus output of the immediately preceding bus unit, appears in the bus system.

7. The machine according to claim 1, wherein the at least one bus unit has a transmitter and a communication controller; and
wherein the transmitter and/or the communication controller are configured, when the bus system is started up, to transmit the messages, which were received by the transceiver at the bus input from the bus, from the bus output to the next bus unit in the bus system.

8. The machine according to claim 7, wherein the bus unit is configured after completion of startup of the bus system, to start a communication in the bus system according to a communication protocol for one serial or parallel transmission of messages.

9. The machine according to claim 1, wherein the bus system is configured to transmit and receive messages according to the Ethernet protocol or a fieldbus protocol between the bus units after completion of the startup, and/or
wherein at least a component is a driving device or sensor or a valve or control device of the machine.

10. The machine according to claim 1, wherein the machine is coupled to a filling machine having as component a driving device for actuating a filling valve with which the container is fillable with a product and/or a driving device for driving a carousel for transporting the containers to or away from a filling valve.

11. A container treatment plant, comprising:
at least one machine selected from the group of machines consisting of a labeling machine, a printing machine, and an inspection machine; and
a bus system, to which the at least one machine is connected for communicating via a bus with an additional container treatment machine and/or to which are connected at least two components of the at least one machine and/or to which is connected a control device of the container treatment plant;
wherein the labeling machine comprises at least one labeling unit for attaching at least one label to a container;
wherein the printing machine comprises at least one printing unit for applying at least one printing to a container;
wherein the inspection machine comprises at least one inspection unit for inspecting a container; and
wherein the machine comprises:
at least two container receptacles, each of which has a turn table with a turn table direct driving device; and
a bus unit for connecting the at least two container receptacles to a bus of a bus system in order to communicate with at least one component of an additional container handling machine or an additional component of the machine;
wherein the bus unit has a bus input and a bus output which are configured such that the bus unit is connected into the bus system serially relative to an additional bus unit of the bus system in order to start up the bus system; and
wherein the bus unit is configured to activate the bus output when starting up the bus system after the bus unit has received an identification number, which uniquely identifies the bus unit during a communication in the bus system, via the bus input.

12. A method for starting up at least one machine selected from the group of machines consisting of a labeling machine, a printing machine, and an inspection machine comprising at least two container receptacles, each having a turntable with a turntable direct driving device, the method comprising the steps of:
connecting a bus unit of the at least two container receptacles to a bus of a bus system for communicating with at least one component of an additional container treatment machine or with an additional component of the machine, wherein the bus unit has a bus input and a bus output configured such that the bus unit for starting up the bus system is serially connected in the bus system to an additional bus unit of the bus system; and
starting up the bus system, wherein the bus output of the bus unit is activated after the bus unit has received via the bus input an identification number which uniquely identifies the bus unit during a communication in the bus system.

13. The machine according to claim 1, wherein the bus system is configured such that the bus input of a bus slave is connected to a bus output of another bus slave.

14. The machine according to claim 2, wherein the component is a controller whose bus unit is configured as a bus master at startup of the bus system, and each bus unit of an additional component of the bus system is configured as a bus slave at startup of the bus system, which is subordinate to the bus master in terms of control.

15. The machine according to claim 2, wherein the bus system is configured such that the bus master is connected to one of the bus slaves, to which all other bus slaves are to be connected one after another in a row.

16. The machine according to claim 2, wherein the bus master is configured at startup of the bus system to transmit to each bus unit of the bus system an identification number after the bus unit, by activating the bus output of the immediately preceding bus unit, appears in the bus system.

17. The machine according to claim 2, wherein the at least one bus unit has a transmitter and a communication controller; and
wherein the transmitter and/or the communication controller are configured, when the bus system is started up, to transmit the messages, which were received by the transceiver at the bus input from the bus, from the bus output to the next bus unit in the bus system.

18. The machine according to claim 17, wherein the bus unit is configured after completion of startup of the bus system, to start a communication in the bus system according to a communication protocol for one serial or parallel transmission of messages.

19. The machine according to claim 2, wherein the bus system is configured to transmit and receive messages according to the Ethernet protocol or a fieldbus protocol between the bus units after completion of the startup, and/or
wherein at least a component is a driving device or sensor or a valve or control device of the machine.

20. The machine according to claim 2, wherein the machine is coupled to a filling machine having as component a driving device for actuating a filling valve with which the container is fillable with a product and/or a driving device for driving a carousel for transporting the containers to or away from a filling valve.

21. The machine according to claim 2, wherein the bus system is configured such that the bus input of a bus slave is connected to a bus output of another bus slave.

22. The machine according to claim 3, wherein the component is a controller whose bus unit is configured as a bus master at startup of the bus system, and each bus unit of an additional component of the bus system is configured as a bus slave at startup of the bus system, which is subordinate to the bus master in terms of control.

23. The machine according to claim 3, wherein the bus system is configured such that the bus master is connected to one of the bus slaves, to which all other bus slaves are to be connected one after another in a row.

24. The machine according to claim 3, wherein the bus master is configured at startup of the bus system to transmit to each bus unit of the bus system an identification number after the bus unit, by activating the bus output of the immediately preceding bus unit, appears in the bus system.

25. The machine according to claim 3, wherein the at least one bus unit has a transmitter and a communication controller; and
wherein the transmitter and/or the communication controller are configured, when the bus system is started up, to transmit the messages, which were received by the transceiver at the bus input from the bus, from the bus output to the next bus unit in the bus system.

26. The machine according to claim 25, wherein the bus unit is configured after completion of startup of the bus system, to start a communication in the bus system according to a communication protocol for one serial or parallel transmission of messages.

27. The machine according to claim 3, wherein the bus system is configured to transmit and receive messages according to the Ethernet protocol or a fieldbus protocol between the bus units after completion of the startup, and/or
wherein at least a component is a driving device or sensor or a valve or control device of the machine.

28. The machine according to claim 3, wherein the machine is coupled to a filling machine having as component a driving device for actuating a filling valve with which the container is Tillable with a product and/or a driving device for driving a carousel for transporting the containers to or away from a filling valve.

29. The machine according to claim 3, wherein the bus system is configured such that the bus input of a bus slave is connected to a bus output of another bus slave.
